(19) United States
(12) Patent Application Publication
(10) Pub. No.: US 2008/0081276 A1
(43) Pub. Date: Apr. 3, 2008

(54) Developer, image forming method, and image forming apparatus

(76) Inventor: Seiji Kikushima, Osaka (JP)

Correspondence Address: Arthur G. Schaier;Carmody & Torrance LLP, P.O. Box 1110, 50 Leavenworth Street, Waterbury, CT, 06721-1110, US

(21) Appl. No.: 11/903,121

(22) Filed: Sep. 19, 2007

(30) Foreign Application Priority Data
Sep. 29, 2006 (JP) 2006-266387

(51) Int. Cl. G03G 9/08

(52) U.S. Cl. 430/110.4; 430/111.41

(57) ABSTRACT

To provide a two-component developer which can maintain the triboelectrification property effectively and can inhibit the generation of fogging effectively even when image formation is performed continuously for a long time by inhibiting inorganic fine particles from burying into a covering resin layer of a carrier to control the degradation of the carrier, and to provide an image forming method and an image forming apparatus using the same. A two-component developer comprising toner particles, a carrier, inorganic fine particles and resin fine particles; and an image forming method and an image forming apparatus using the same are provided. In the two-component developer, a surface of the carrier has a covering resin layer, and when it is assumed that an intensity of fluorescent X-rays due to elements derived from the inorganic fine particles on the surface of the carrier before use is X1, and an intensity of fluorescent X-rays due to elements derived from the inorganic fine particles on the surface of the carrier after production of 300,000 sheets of image patterns in accordance with ISO 12647 at an image density of 5% is X2, the X1 and X2 satisfy the following relation (1):
X2/X1≦15 (1)

### BACKGROUND OF THE INVENTION

1. Field of the Invention

The present invention relates to a developer, an image forming method and an image forming apparatus, and particularly relates to a two-component developer which can maintain its triboelectrification property effectively and can prevent generation of fogging effectively even when image formation is performed continuously for a long time, and to an image forming method and an image forming apparatus using the developer.

2. Description of the Related Art

Generally, an electrophotographic system is classified roughly into two categories, that is, a monocomponent development system using only insulating toner particles or conductive toner particles and a two-component development system using toner particles and carriers.

Among these, the two-component development system, in which toner particles are frictionally charged through carriers, is superior in triboelectrification property of a developer to the monocomponent development.

In the field of such two-component developers used in the two-component development system, in order to control the triboelectrification of toner particles and carriers in desired ranges, a method is used in which the fluidity of a developer is adjusted by use of inorganic fine particles, such as silica, as an additive.

However, when such inorganic fine particles are used as an additive, a problem is recognized in which the charging property of the overall developer easily changes due to the charging property of the inorganic fine particles themselves.

Another problem is also recognized in which inorganic fine particles having a relatively high hardness bury into toner particles to make the charging property or the fluidity of toner particles unstable.

In order to solve such problems, an approach of adding resin fine particles as well as inorganic fine particles to a developer has been disclosed (for example, Patent Document 1).

More specifically, Patent Document 1 discloses a two-component developer in which the average particle diameter and the viscosity under given conditions of the toner particles, the particle size relation among the toner particles, the resin fine particles and the inorganic fine particles, and the charge quantities of these particles are prescribed.

Patent Document 1 also discloses that it is possible to inhibit the inorganic fine particles from being charged excessively and also prevent the inorganic fine particles from burying into the toner particles by the function of the resin fine particles as a cushioning material.

[Patent document 1] JP2884410B (Claims)

However, as for the two-component developer disclosed in patent document 1, the burying of the inorganic fine particles into the toner particles is taken into consideration, but the burying of the inorganic fine particles into the covering resin layer of the carrier is overlooked. Therefore, when image formation is performed continuously for a long time by use of a carrier having a covering resin layer, the triboelectrification property in the carrier tends to deteriorate and, as a result, the developer as a whole tends to be short in charge quantity. This has led to a problem that fogging tends to occur in images formed.

### SUMMARY OF THE INVENTION

Then, the inventors of the present invention have investigated intensively and have found that, when resin fine particles (fine particles made by a resin) and inorganic fine particles (fine particles made by an inorganic material) are also included as additives in a two-component developer including a carrier having a covering resin layer, an intensity ratio of fluorescent X-rays due to elements derived from the inorganic fine particles on the surface of a carrier before use to that due to elements derived from the inorganic fine particles on the surface of a carrier after a predetermined image formation, is adjusted to a predetermined range, whereby it is possible to maintain a triboelectrification property of the developer effectively even when image formation is performed continuously for a long time. They accomplished the present invention based on this finding.

An object of the present invention is to provide a two-component developer which can maintain its triboelectrification property effectively and can inhibit generation of fogging effectively even when image formation is performed continuously for a long time by inhibiting inorganic fine particles from burying into a covering resin layer of a carrier to thereby control degradation of the carrier, and to provide an image forming method and an image forming apparatus using the same.

According to one aspect of the present invention, in order to solve the above-described problems, there is provided a two-component developer comprising toner particles, resin fine particles, inorganic fine particles and a carrier, wherein a surface of the carrier has a covering resin layer, and when it is assumed that an intensity of fluorescent X-rays due to elements derived from the inorganic fine particles on the surface of the carrier before use is X1, and an intensity of fluorescent X-rays due to elements derived from the inorganic fine particles on the surface of the carrier after production of 300,000 sheets of image patterns in accordance with ISO 12647 at an image density of 5% is X2, the X1 and X2 satisfy the following relation (1):
X2/X1≦15 (1)

In other words, by adjusting a ratio of the intensity of fluorescent X-rays due to elements originating from the inorganic fine particles on the surface of a carrier before use to that due to elements originating from the inorganic fine particles on the surface of a carrier after predetermined image formation within a predetermined range, it is possible to effectively inhibit the inorganic fine particles from burying into the covering resin layer of the carrier.

Therefore, even if image formation is performed continuously for a long time, controlling the degradation of the carrier makes it possible to maintain the triboelectrification property in the developer effectively and inhibit generation of fogging effectively.

In constituting the two-component developer of the invention, it is desirable that the Vickers hardness of the resin fine particles measured in accordance with JIS B7725 and JIS Z2244 be adjusted to a value smaller than the Vickers hardness of the covering resin layer in the carrier measured in accordance with the same standards as those for the resin fine particles.

By adopting such a constitution, inorganic fine particles separated from toner particles will bury into resin fine particles more selectively. This allows an amount of inorganic fine particles burying into the resin covering resin layer of the carrier to be reduced.

It therefore is possible to satisfy the relation (1) more easily.

In constituting the two-component developer of the invention, it is desirable to adjust an average primary particle diameter of the resin fine particles to a value within the range of from 50 to 500 nm.

By adopting such a constitution, it is possible to bury inorganic fine particles separated from toner particles in resin fine particles more effectively and to control the charging property and fluidity of the developer easily.

In constituting the two-component developer of the invention, it is desirable to adjust the addition quantity of the resin fine particles to a value within the range of from 0.1 to 5 parts by weight based on 100 parts by weight of the toner particles.

By adopting such a constitution, it is possible to bury inorganic fine particles separated from toner particles in resin fine particles more effectively and to control the charging property and fluidity of the developer easily.

In constituting the two-component developer of the invention, it is desirable that the resin fine particles comprise an acrylic resin as their major ingredient.

This constitution allows the Vickers hardness, charging property or the like of the resin fine particles to be controlled more easily.

In constituting the two-component developer of the invention, it is desirable that, when a charge quantity per unit mass of the toner particles, a charge quantity per unit mass of the carrier and a charge quantity per unit mass of the resin fine particles are indicated by Q1, Q2 and Q3, respectively, the Q1, Q2 and Q3 satisfy the following relation (2):
Q1>Q2>Q3 (2).

With this constitution, inorganic fine particles separated from toner particles can be buried in resin particles efficiently.

Another aspect (embodiment) of the present invention is an image forming method, wherein any one of the two-component developers mentioned above is used.

The two-component developer used in the invention can maintain the triboelectrification property in the developer effectively even in the case of performing image formation continuously for a long time.

Therefore, use of the image forming method of the invention makes it possible to, even in the event that image formation is performed continuously for a long time, stably form images in which the generation of fogging is inhibited effectively.

Still another aspect (embodiment) of the present invention is an image forming apparatus, wherein any one of the two-component developers mentioned above is used.

The two-component developer used in the invention can maintain the triboelectrification property in the developer effectively even in the case of performing image formation continuously for a long time.

Therefore, use of the image forming apparatus of the invention makes it possible to, even in the event that image formation is performed continuously for a long time, stably form images in which the generation of fogging is inhibited effectively.

### BRIEF DESCRIPTION OF THE DRAWINGS

FIG. 1 is a diagram for illustrating a relationship between a fluorescent X-ray intensity ratio and a charge quantity of a developer;

FIG. 2 is a diagram for illustrating a relationship between the fluorescent X-ray intensity ratio and fogging;

FIG. 3 is a diagram for illustrating an image forming apparatus of the present invention; and

FIG. 4 is a diagram for illustrating a developing device.

### DESCRIPTION OF THE PREFERRED EMBODIMENTS

### First Embodiment

A first embodiment is a two-component developer comprising toner particles, resin fine particles, inorganic fine particles and a carrier, wherein a surface of the carrier has a covering resin layer, and when it is assumed that an intensity of fluorescent X-rays due to elements derived from the inorganic fine particles on the surface of a carrier before use is X1, and an intensity of fluorescent X-rays due to elements derived from the inorganic fine particles on the surface of a carrier after continuous production of 300,000 sheets of image patterns in accordance with ISO 12647 at an image density of 5% is X2, the X1 and X2 satisfy the following relation (1):
X2/X1≦15 (1)

In the following, the developer of the first embodiment is described by separating it into its constituent features.

1. Toner Particle

(1) Binding Resin

The kind of a binding resin used for toner particles is not particularly restricted. It is desirable to use, for example, a theremoplastic resin such as a styrene resin, an acrylic resin, a styrene-acrylic copolymer, a polyethylene resin, a polypropylene resin, a vinyl chloride resin, a polyester resin, a polyamide resin, a polyurethane resin, a polyvinyl alcohol resin, a vinyl ether resin, an N-vinyl resin and a styrene-butadiene resin.

(2) Coloring Agent

The kind of a coloring agent to be contained in toner particles is not particularly restricted. It is desirable to use, for example, carbon black, acetylene black, lamp black, aniline black, azo pigment, yellow iron oxide, ochre, a nitro dye, an oil-soluble dye, a benzidine pigment, a quinacridone pigment, and a copper phthalocyanine pigment.

The addition quantity of the coloring agent, which is not particularly restricted, is preferably adjusted, for example, to a value within the range of from 0.01 to 30 parts by weight based on 100 parts by weight of the binding resin of the toner particles.

The reason for this is that if the addition quantity of the coloring agent is a value less than 0.01 part by weight, the image density is reduced and it may be difficult to obtain clear images, while on the other hand, when the addition quantity of the coloring agent is a value greater than 30 parts by weight, the fixing property may deteriorate.

For such reasons, it is more desirable to adjust the addition quantity of the coloring agent to a value within the range of from 0.1 to 20 parts by weight, and even more desirably to a value within the range of from 0.5 to 15 parts by weight based on 100 parts by weight of the binding resin of the toner particles.

(3) Charge Control Agent

It is desirable to add a charge control agent to the toner particles.

The reason for this is that addition of a charge control agent can greatly improve the charge level or the charge rise characteristic, which is an index showing whether a material is charged to a certain charge level or not.

The kind of such a charge control agent is not particularly restricted. It is desirable to use, for example, a charge control agent which exhibits a positive charging property, such as nigrosine, quaternary ammonium salt compounds and resin-type charge control agents comprising resin and an amine compound bonded thereto.

It is preferable to adjust the addition quantity of the charge control agent to a value within the range of from 0.5 to 10 parts by weight based on 100 parts by weight of the binding resin of the toner particles.

The reason for this is that if the addition quantity of the charge control agent is a value less than 0.5 part by weight, the effects due to the charge control agent may fail to be exhibited, while on the other hand, if the addition quantity of the charge control agent is a value greater than 10 parts by weight, defective charging or a defective image may be easily produced particularly under high temperature and high humidity conditions.

For such reasons, it is more desirable to adjust the addition quantity of the charge control agent to a value within the range of from 1 to 9 parts by weight, and even more desirably to a value within the range of from 2 to 8 parts by weight based on 100 parts by weight of the binding resin of the toner particles.

(4) Wax

Wax is preferably added to toner particles.

Examples of the wax include, without being particularly limited thereto, a single substance or combinations of two or more substances selected from polyethylene wax, polypropylene wax, fluororesin wax, Fischer Tropsch wax, paraffin wax, ester wax, montan wax, rice wax, and the like.

It is preferable to adjust the addition quantity of the wax to a value within the range of from 0.1 to 20 parts by weight based on 100 parts by weight of the binding resin of the toner particles.

This is because when the addition quantity of the wax is a value less than 0.1 part by weight, it may become difficult to prevent image smearing or the like effectively, while on the other hand, when the addition quantity of the wax is a value greater than 20 parts by weight, the preservation stability may be worsen due to fusion of toner particles.

For such reasons, it is more desirable to adjust the addition quantity of the wax to a value within the range of from 0.5 to 15 parts by weight, and even more desirably to a value within the range of from 1 to 10 parts by weight based on 100 parts by weight of the binding resin of the toner particles.

(5) Volume Average Particle Diameter

A volume average particle diameter of the toner particles is desirably adjusted to a value within the range of from 5 to 20 μm.

The reason for this is that when the volume average particle diameter of the toner particles is a value less than 5 μm, it may become difficult to produce the toner particles stably or the cleaning efficiency for a residual toner may lower, while on the other hand, when the volume average particle diameter of the toner particles is a value greater than 20 μm, it may become difficult to obtain high-quality images.

For such reasons, it is more desirable to adjust the volume average particle diameter of the toner particles to a value within the range of from 7 to 15 μm, and even more desirably to a value within the range of from 9 to 13 μm.

The volume average particle diameter of the toner particles can be measured using, for example, a Coulter multisizer 3 available from Beckman Coulter, Inc.

(6) Production Method

With regard to a method for producing toner particles, a resin composition for a toner is prepared by preliminarily mixing the aforementioned binding resin, wax, coloring agent and, if necessary, other additives by a conventional method, followed by melt-kneading. It is desirable to obtain toner particles by, subsequent to the preparation of the resin composition, finely grinding the resulting resin composition for a toner by a conventional method and then subjecting it to pulverizing classification.

The preliminary mixing is conducted desirably by using, for example, a Henschel mixer, a ball mill, a super mixer, or a dry blender.

The melt-kneading is conducted desirably by using, for example, a twin screw extruder or a single screw extruder. The finely grinding is conducted desirably by using, for example, an air granulator or the like. The classification is conducted desirably by using, for example, an air classifier or the like.

2. Inorganic Fine Particle

Inorganic fine particles are characteristically added as an additive to toner particles.

This is because addition of inorganic fine particles allows control of the fluidity of the developer, and further controlling the fluidity of the developer makes it possible to adjust the triboelectrification between a toner particle and a carrier within a desired range.

(1) Kind

Such inorganic fine particles are not particularly restricted, but preferable examples include silica particles or titanium oxide particles.

It is preferable to apply hydrophobicizing treatment to the inorganic fine particles. For example, silica particles can be subjected to hydrophobicizing treatment by use of an organosilicon compound such as dimethyl polysiloxane, 3-aminopropyl trimethoxysilane, hexamethyldisilazane, trimethylsilane, trimethylchlorosilane, trimethylethoxysilane, dimethyldichlorosilane, methyltrichlorosilane and allyldimethylchlorosilane.

On the other hand, titanium oxide particles can be subjected to hydrophobicizing treatment by use of a titanate compound such as isopropyl triisostearoyl titanium, vinyl trimethoxy titanium, naphthyl trimethoxy titanium, phenyl trimethoxy titanium, methyl trimethoxy titanium, ethyl trimethoxy titanium, propyl trimethoxy titanium, isobutyl trimethoxy titanium and octadecyl trimethoxy titanium.

(2) Average Particle Diameter

An average particle diameter of the inorganic fine particles is desirably adjusted to a value within the range of from 2 to 100 nm.

The reason for this is that when the average particle diameter is a value less than 2 nm, ununiform agglomeration tends to occur and it may become difficult to add them to toner particles uniformly, while on the other hand, when the average particle diameter is a value exceeding 100 nm, variation in the charge quantity of the developer may increase or, as described later, it may become difficult for the inorganic fine particles to bury into resin fine particles.

For such reasons, it is more desirable to adjust the average particle diameter of the inorganic fine particles to a value within the range of from 5 to 80 nm, and even more desirably to a value within the range of from 7 to 60 nm.

Here, the average particle diameter of inorganic fine particles may be determined by measuring long diameters and short diameters of 50 particles respectively by use of an electron microscope JSM-880 (produced by JEOL DATUM LTD.) at a magnification of 30,000 times to 100,000 times, and then calculating the average of the long diameters and the average of the short diameters.

(3) Addition Quantity

It is desirable to adjust the addition quantity of the inorganic fine particles to a value within the range of from 0.1 to 5 parts by weight based on 100 parts by weight of the toner particles.

The reason for this is that when the addition quantity of the inorganic fine particles is a value less than 0.1 part by weight, the fluidity of the developer may decrease to thereby remarkably deteriorate the charging property of the developer particularly under high temperature and high humidity conditions, while on the other hand, when the addition quantity of the inorganic fine particles is a value greater than 5 parts by weight, it will become difficult to inhibit inorganic fine particles separated from toner particles from burying into the covering resin layer of the carrier and therefore, when image formation is performed continuously for a long time, the charging property of the developer may be remarkably deteriorated.

It is more desirable to adjust the addition quantity of the inorganic fine particles to a value within the range of from 0.4 to 4 parts by weight based on 100 parts by weight of the toner particles.

3. Resin Fine Particle

The developer of the present invention is characterized by including resin fine particles as an additive.

This is because inclusion of resin fine particles as an additive makes it possible to effectively inhibit inorganic fine particles separated from toner particles from burying into the covering resin layer of the carrier.

In other words, that is because selective burying of separated inorganic fine particle into resin fine particles makes it possible to effectively inhibit the separated inorganic fine particles from burying excessively into the covering resin layer of the carrier and, thereby, to control the deterioration of the carrier even in the case of performing image formation continuously for a long time.

Here, description will be given to the outline about the burying of the separated inorganic fine particles into the covering resin layer of the carrier.

Unlike toner particles or the like, a carrier is not consumed in the process of performing image formation. This is because unlike toner particles or the like, a carrier is not supported on a developing sleeve and it naturally is not transferred to paper.

Therefore, when image formation is performed continuously for a long time, the separated inorganic fine particle may easily bury into the covering resin layer of the carrier excessively. As a result, the triboelectrification property in the carrier may deteriorate due to the progress of degradation of the carrier, and then the charge quantity as the whole developer may become insufficient, leading to occurrence of fogging in images formed.

(1) Binding Resin

As the binding resin in resin fine particles, biding resins similar to those used as the binding resin of toner particles may be used. Available examples of the binding resin include a thermoplastic resin such as a styrene resin, an acrylic resin, a styrene-acrylic copolymer, a polyethylene resin, a polypropylene resin, a vinyl chloride resin, a polyester resin, a polyamide resin, a polyurethane resin, a polyvinyl alcohol resin, a vinyl ether resin, an N-vinyl resin and a styrene-butadiene resin.

Among the binding resins shown above, use of an acrylic resin is particularly preferred.

This is because any acrylic resin allows the Vickers hardness, charging property or the like of the resin fine particles to be controlled to desirable ranges as described later.

Specific examples of the acrylic resin include an acrylic resin, a methacrylic resin, a styrene-acrylic ester copolymer, a styrene-methacrylic ester copolymer, and a styrene-methyl a-chloromethacrylate copolymer.

(2) Vickers Hardness

It is desirable to adjust the Vickers hardness (at 23° C.) of resin fine particles measured in accordance with JIS B7725 and JIS Z2244 to a value within the range of from 5 to 17 kg/mm².

The reason for this is that when the Vickers hardness of resin fine particles is less than 5 kg/mm², the resin fine particles will adhere to toner particles or a carrier too easily, and therefore the fluidity of the developer may be reduced, while on the other hand, when the Vickers hardness in resin fine particles is a value greater than 17 kg/mm², a difference between the Vickers hardness of the resin fine particles and the Vickers hardness of the covering resin layer of the carrier will become insufficient and it may become difficult to cause the inorganic fine particles separated from the toner particles to bury into the resin fine particles selectively.

For such reasons, it is more desirable to adjust the Vickers hardness of the resin fine particles to a value within the range of from 7 to 16 kg/mm², and even more desirably to a value within the range of from 10 to 15 kg/mm².

A method for measuring the Vickers hardness will be described in Examples shown below.

(3) Average Particle Diameter

Desirably, an average particle diameter of the resin fine particles is adjusted to a value within the range of from 50 to 500 nm.

This is because by adjusting the average particle diameter of the resin fine particles to a value within that range, it is possible to cause inorganic fine particles separated from toner particles to bury into the resin fine particles effectively and it is also possible to control the charging property and fluidity of the developer easily.

In other words, that is because if the average particle diameter of resin fine particles is a value less than 50 nm, it may become difficult to cause separated inorganic: fine particles to bury efficiently due to the relationship in size with the inorganic fine particles, while on the other hand, when the average particle diameter of resin fine particles is a value greater than 500 nm, the resin fine particles may be separated from toner particles to affect the fluidity of the toner particles or the carrier, resulting in insufficient triboelectrification of the toner particles.

It therefore is more desirable to adjust the average particle diameter of the resin fine particles to a value within the range of from 50 to 300 nm.

(4) Addition Quantity

It is desirable to adjust the addition quantity of the resin fine particles to a value within the range of from 0.1 to 5 parts by weight based on 100 parts by weight of the toner particles.

The reason for this is that when the addition quantity of the resin fine particles is a value less than 0.1 part by weight, the effect of burying of inorganic fine particles separated from the toner particles into the resin fine particles may fail to be exhibited, while on the other hand, when the addition quantity of the resin fine particles is a value greater than 5 parts by weight, the fluidity of the toner particles or the carrier will be affected or the triboelectrification of the toner particles will become insufficient, with the result that the image density may be reduced easily.

For such reasons, it is more desirable to adjust the addition quantity of the resin fine particles to a value within the range of from 0.3 to 3 parts by weight, and even more desirably to a value within the range of from 0.8 to 1.5 parts by weight based on 100 parts by weight of the toner particles.

(5) Production Method

The resin fine particles can be produced by emulsion polymerization, spray drying or the like. A particularly desirable production method is emulsion polymerization.

The following is a concrete description about the emulsion polymerization. For example, a solution is prepared which contains a surfactant such as sodium lauryl sulfate and a polymerization initiator such as ammonium persulfate. Subsequently, a monomer component, such as acrylic acid, methyl methacrylate, butyl acrylate, 2-ethylhexyl acrylate and styrene, is dropped to the solution to yield an emulsion. Finally, the emulsion is dried to obtain resin fine particles.

4. Carrier

The carrier used for the two-component developer as the invention is characterized by comprising a carrier core and a covering resin layer which covers the carrier core.

This is because the covering resin layer allows the insulation property of the carrier to be improved to adjust the triboelectrification property between the carrier and the toner particles within a desirable range and also to improve the durability of the carrier.

(1) Carrier Core

Examples of the carrier core include metal or alloy which shows ferromagnetism, such as ferrite, magnetite, iron, cobalt and nickel, or compounds containing such ferromagnetic elements, or alloy which is free of ferromagnetic elements but which will show ferromagnetism through application of appropriate heat treatment.

It is also desirable to use, as a carrier core, a material obtained by dispersing the above-mentioned magnetic powder in a binder resin, such as a polyvinyl alcohol resin and a polyvinyl acetal resin, followed by granulation. That is, core elementary particles can be obtained by mixing and dispersing a magnetic powder, a binder resin and, according to demand, additives or the like, followed by granulation and drying. Thereafter, the resulting carrier core elementary particles are calcined and pulverized using a conventional method, thereby to obtain a carrier core.

(2) Covering Resin Layer

As the covering resin layer of the carrier, suitable used are an epoxy resin, a silicone resin, a fluororesin and the like.

This is because any of such resins can control the Vickers hardness or charging property of the covering resin layer to desirable ranges as described later.

Desirably, the covering resin quantity is adjusted to a value within the range of from 5 to 60 parts by weight based on 100 parts by weight of the carrier core.

The reason for this is that when the covering resin quantity is a value less than 5 parts by weight, it is impossible to cover the carrier core sufficiently and, as a result, the charging property or durability may deteriorate, while on the other hand, when the covering resin quantity is a value greater than 60 parts by weight, the fluidity may deteriorate or spent may tend to occur.

For such reasons, it is more desirable to adjust the covering resin quantity to a value within the range of from 10 to 50 parts by weight, and even more desirably to a value within the range of from 15 to 45 parts by weight based on 100 parts by weight of the carrier core.

It is desirable to use additives to the covering resin layer of the carrier. Examples of such additives include inorganic fine particles, such as titanium oxide, zinc oxide and silica, a curing agent and a coloring agent.

It is desirable to adjust the addition quantity of such an additive to a value within the range of from 0.1 to 20 parts by weight based on 100 parts by weight of the covering resin.

It is preferable to adjust the Vickers hardness (under 23° C.) in the covering resin layer measured in accordance with JIS B7725 and JIS Z2244 to a value within the range of from 10 to 30 kg/mm².

The reason for this is that when the Vickers hardness in the covering resin layer is less than 10 kg/mm², it may become difficult to inhibit inorganic fine particles from burying into the covering resin layer, while on the other hand, when the Vickers hardness in the covering resin layer is a value greater than 30 kg/mm², the covering resin layer may tend to peel off from the carrier core or the triboelectrification property may deteriorate.

For such reasons, it is more desirable to adjust the Vickers hardness in the covering resin layer to a value within the range of from 12 to 25 kg/mm², and even more desirably to a value within the range of from 15 to 20 kg/mm².

The method for measuring the Vickers hardness swill be described in Examples, but the mode of the measurement is not particularly restricted. For example, it may be measured when a covering resin layer is on a carrier core or when a covering resin layer is left alone.

(3) Average Particle Diameter

It is desirable to adjust the average particle diameter of the carrier to a value within the range of from 20 to 120 μm.

This is because when the average particle diameter of the carrier is a value less than 20 μm, carrier jumping may tend to occur, while on the other hand, when the average particle diameter of the carrier is a value greater than 120 μm, the fluidity of the whole developer may deteriorate.

For such reasons, it is more desirable to adjust the average particle diameter of the carrier to a value within the range of from 30 to 110 μm, and even more desirably to a value within the range of from 40 to 100 μm.

(4) Addition Quantity

It is desirable to adjust the addition quantity of the carrier to a value within the range of from 50 to 5000 parts by weight based on 100 parts by weight of the toner particles.

The reason for this is that when the addition quantity of the carrier is a value less than 50 parts by weight, it may become difficult to sufficiently triboelectrically charge toner particles containing resin fine particles added, while on the other hand, when the addition quantity of the carrier is a value greater than 5000 parts by weight, the fluidity of the whole developer may deteriorate or carrier jumping may tend to occur.

For such reasons, it is more desirable to adjust the addition quantity of the carrier to a value within the range of from 100 to 3000 parts by weight, and even more desirably to a value within the range of from 200 to 2000 parts by weight based on 100 parts by weight of the toner particles.

(5) Production Method

Regarding a method for forming a covering resin layer on a carrier core, it is desirable, for example, to coat a carrier core with a solution prepared by dissolving a covering resin in a proper solvent using proper means such as spraying or a fluidized bed. It is also desirable to dry and calcine the resulting mixed mass of the covering resin and the carrier core, pulverize it with a hammer mill or the like, and further subject it to classification treatment using an air classifier or the like.

5. Characteristics of Developer

(1) Fluorescent X-ray Intensity Ratio

The two-component developer of the invention is characterized in that when an intensity of fluorescent X-rays due to elements derived from the inorganic fine particles on the surface of a carrier before use is indicated by X1, and an intensity ratio of fluorescent X-rays due to elements derived from the inorganic fine particles on the surface of a carrier after production of 300,000 sheets of image patterns in accordance with ISO 12647 at an image density of 5% is indicated by X2, the X1 and X2 satisfy the following relation (1):
X2/X1≦15 (1)

This is because it is possible to effectively inhibit the separated inorganic fine particles from burying into the covering resin layer of the carrier, by adjusting the ratio of the intensity of fluorescent X-rays due to elements derived from the inorganic fine particles on the surface of a carrier before use to that due to elements derived from the inorganic fine particles on the surface of a carrier after predetermined image formation within a certain range.

Accordingly, that is because even if image formation is performed continuously for along time, it is possible to maintain the triboelectrification property in the developer effectively and inhibit generation of fogging effectively by controlling the degradation of the carrier.

In other words, that is because when the value of the fluorescent X-ray intensity ratio (X2/X1) is a value exceeding 15, it is quantitatively shown that separated inorganic fine particles tend to bury into the covering resin layer of the carrier excessively easily due to the characteristics, such as Vickers hardness, in the resin fine particles and in the covering resin layer of the carrier.

Accordingly, the value of the fluorescent X-ray intensity ratio (X2/X1) more preferably satisfies the following relation (1′), and even more preferably satisfies the following relation (1″):
1≦X2/X1≦12 (1′)
1≦X2/X1≦10 (1″)

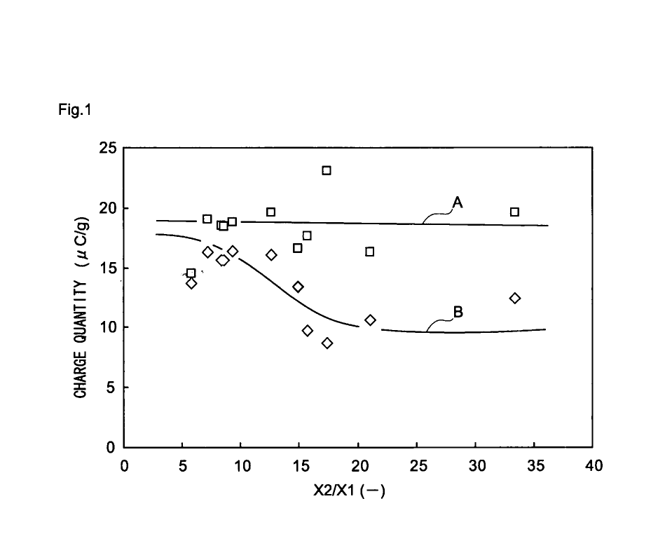

Next, with reference to FIG. 1, description will be given to a relationship between the intensity ratio (X2/X1) of fluorescent X-rays due to elements derived from the inorganic fine particles on the surface of a carrier after continuous production of 300,000 sheets of image patterns in accordance with ISO 12647 at an image density of 5% and a charge quantity of toner particles used together with the carrier.

In FIG. 1 shown are characteristic curves A and B in which the intensity ratio (X2/X1)(−) of fluorescent X-rays due to elements derived from the inorganic fine particles on the surface of a carrier after continuous production of 300,000 sheets of image patterns in accordance with ISO 12647 at an image (density of 5% is the abscissa and the charge quantity (μC/g) of the developer (except the carrier) is the ordinate.

Here, the characteristic curve B is a characteristic curve in a case where 300,000 sheets of image patterns in accordance with ISO 12647 at an image density of 5% have been produced continuously.

On the other hand, the characteristic curve A is a characteristic curve in a case where 50,000 sheets of image patterns in accordance with ISO 12647 at an image density of 2% were produced intermittently using the same developers as those used in the characteristic curve B.

Note that each of the abscissas in the characteristic curves A and B indicates the intensity ratio (X2/X1)(−) of fluorescent X-rays due to the elements derived from the inorganic fine particles on the surface of a carrier after continuous production of 300,000 sheets of image patterns in accordance with ISO 12647 at an image density of 5%.

As understood from the characteristic curve B, it is shown that in the region where the value of the fluorescent X-ray intensity ratio (X2/X1) (−) is 15 or less, although the value of the charge quantity (μC/g) of the developers decreases sharply with increase in that ratio, the value of the charge quantity (μC/g) of the developers is maintained within a range about 15 μC/g. It is also shown that when the value of the fluorescent X-ray intensity ratio (X2/X1) (−) becomes values exceeding 15, on the other hand, the charge quantity of the developers becomes low values as low as about 10 μC/g regardless of the change of that ratio.

Further, the characteristic curve A indicates that even when the developers used are changed in the same manner as in the characteristic curve B, the values of the charge quantity (μC/g) of the developers are maintained stably at values just under 20 μC/g.

Therefore, it is shown that particularly when image formation is performed continuously for along time (for example, 300,000 sheets continuously) as in the case of the characteristic curve B, the intensity ratio (X2/X1) of the fluorescent X-rays due to the elements derived from the inorganic fine particles on the surface of the carrier increases and the charge quantity of the developers also decreases accordingly. It is also shown that even when image formation is performed continuously for a long time, it is possible to maintain the charge quantity of the developers at critically high values by adjusting the intensity ratio (X2/X1) of the fluorescent X-rays due to the elements derived from the inorganic fine particles on the surface of the carrier to values of 15 or less.

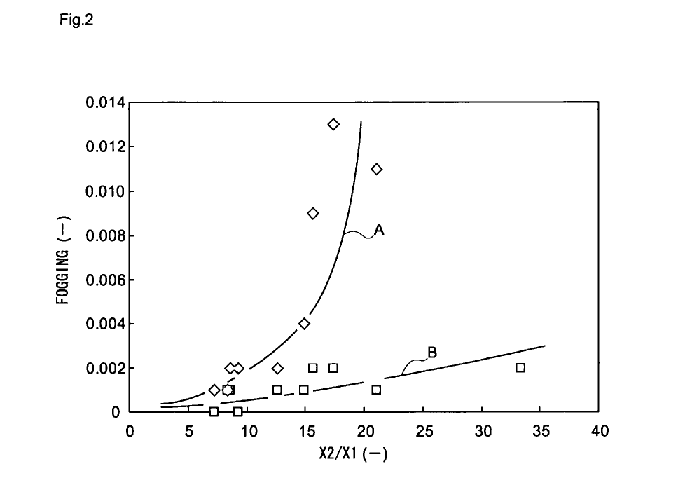

Next, with reference to FIG. 2, description will be given to a relationship between the intensity ratio (X2/X1) of fluorescent X-rays due to the elements derived from the inorganic fine particles on the surface of a carrier after continuous production of 300,000 sheets of image patterns in accordance with ISO 12647 at an image density of 5% and fogging occurring when image formation is performed using a developer containing the carrier.

In FIG. 2 shown are characteristic curves A and B in which the intensity ratio (X2/X1) (−) of fluorescent X-rays due to elements derived from the inorganic fine particles on the surface of a carrier after continuous production of 300,000 sheets of image patterns in accordance with ISO 12647 at an image density of 5% is the abscissa and fogging (−) occurring when image formation is performed using a developer containing the carrier is the ordinate.

Here, the characteristic curve A is a characteristic curve in a case where 300,000 sheets of image patterns in accordance with ISO 12647 at an image density of 5% have been produced continuously.

On the other hand, the characteristic curve B is a characteristic curve in a case where 50,000 sheets of image patterns in accordance with ISO 12647 at an image density of 2% have been produced intermittently using the same developers as those used in the characteristic curve A.

Note that as in the case shown in FIG. 1, each of the abscissas in the characteristic curves A and B indicates the intensity ratio (X2/X1) of fluorescent X-rays due to elements derived from the inorganic fine particles on the surface of a carrier after continuous production of 300,000 sheets of image patterns in accordance with ISO 12647 at an image density of 5%.

As clear from the characteristic curve A, the value of the fogging (−) increases as the value of the fluorescent X-ray intensity ratio (X2/X1)(−) increases.

More specifically, it is shown that when the value of the fluorescent X-ray intensity ratio (X2/X1) (−) is 15 or less, the value of the fogging (−) increases relatively gradually with increase in that ratio and it maintains values of 0.005 or less. It is also shown that in the region where the value of the fluorescent X-ray intensity ratio (X2/X1) (−) exceeds 15, on the other hand, the value of the fogging (−) increases sharply with increase in that ratio.

Further, the characteristic curve B indicates that even when the developers used are changed in the same manner as in the characteristic curve A, only the value of the fogging (−) increases at an almost constant and very gentle increase rate unlike in the characteristic curve A.

Therefore, it is shown that particularly when image formation is performed continuously for a longtime (for example, 300,000 sheets continuously) as in the case of the characteristic curve A, the intensity ratio (X2/X1) of the fluorescent X-rays due to elements derived from the inorganic fine particles on the surface of a carrier increases and the fogging also sharply increases accordingly. It is also shown that even when image formation is performed continuously for a long time, it is possible to control the fogging at critically low values by adjusting the intensity ratio (X2/X1) of the fluorescent: X-rays due to the elements derived from the inorganic fine particles on the surface of the carrier to values of 15 or less.

(2) Vickers Hardness

Desirably, the Vickers hardness of the resin fine particles measured in accordance with JIS B7725 and JIS Z2244 is adjusted to a value smaller than the Vickers hardness of the covering resin layer in the carrier measured in accordance with the same standards as those for the resin fine particles.

This is because by adjusting the Vickers hardness of resin fine particles to be lower than the Vickers hardness of the covering resin layer of a carrier, inorganic fine particles separated from toner particles may bury into resin fine particles more selectively and this allows the amount of inorganic fine particles burying into the resin covering resin layer of the carrier to be reduced.

The difference between the Vickers hardness of the covering resin layer in a carrier and the Vickers hardness of resin fine particles is desirably a value within the range of 2 to 10 kg/mm² at 23° C.

That is also because when the difference in Vickers hardness is a value less than 2 kg/mm², the difference between the Vickers hardness of the resin fine particles and the Vickers hardness of the covering resin layer of a carrier may become insufficient and it may become difficult to cause the inorganic fine particles to bury into the resin fine particles selectively; while on the other hand, when the difference in Vickers hardness is over 10 kg/mm², the hardness of the resin fine particles is so low or the hardness of the covering resin layer in the carrier is so high that the fluidity or charging property of the developer may be remarkably deteriorated.

For such reasons, it is more desirable to adjust the difference between the Vickers hardness of the covering resin layer in the carrier and the Vickers hardness of the resin fine particles to a value within the range of from 3 to 9 kg/mm², and even more desirably to a value within the range of from 4 to 8 kg/mm².

(3) Charge Quantity

Further, Q1, Q2 and Q3 desirably satisfy the following relation (2), where the charge quantity per unit mass of the toner particles, the charge quantity per unit mass of the carrier and the charge quantity per unit mass of the resin fine particles are indicated by Q1, Q2 and Q3, respectively:
Q1>Q2>Q3 (2).

The reason for this is that it is possible to bury the inorganic fine particles separated from the toner particles in the resin particles efficiently, by adjusting the charge quantities per unit mass of the toner particles, the carrier and the resin fine particles to that relationship.

In other words, generally, the electrification polarity of resin fine particle and carriers is often negative, whereas the electrification polarity of toner particles and inorganic fine particles is often positive.

Therefore, that is because when Q1, Q2 and Q3, which are respectively the charge quantities per unit mass of the toner particles, the carrier and the resin fine particles, satisfy the following relation (2), it is possible to bury inorganic fine particles separated from the toner particles selectively into the resin fine particles while improving the triboelectrification property between the toner particles and the carrier or the adding property of the resin fine particles to the toner particles.

A method for measuring the aforementioned charge quantity is disclosed in Examples.

### Second Embodiment

A second embodiment is directed to an image forming method and an image forming apparatus, wherein any one of the two-component developers described in the first embodiment is used.

In the following, the image forming method and the image forming apparatus of the second embodiment are described by omitting the contents overlapping the first embodiment and focusing mainly on the points different from the first embodiment.

1. Image Forming Apparatus

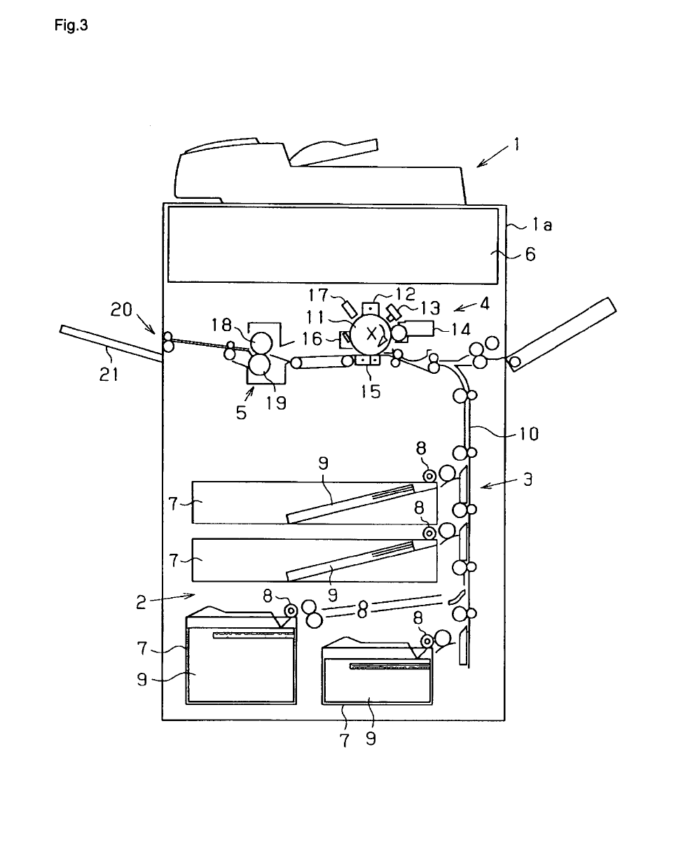

In performing the image forming method according to the second embodiment, the image forming method is preferably applicable to an image forming apparatus 1 shown in FIG. 3.

FIG. 3 is a schematic diagram showing the whole constitution of the image forming apparatus. The image forming apparatus 1 includes a paper feeding portion 2 which is arranged in a lower portion of an image forming apparatus body 1a, a paper conveying part 3 which is arranged on a side of and above the paper feeding portion 2, an image forming part 4 which is arranged above the paper conveying part 3, a fixing part 5 which is arranged at a position closer to a discharge side than the image forming part 4, and an image reading portion 6 which is arranged above the image forming part 4 and the fixing part 5.

Further, the paper feeding portion 2 includes a plurality of (four in this embodiment) paper feeding cassettes 7 which store papers 9. Due to a rotational operation of a paper feeding roller 8, the papers 9 are fed to the paper conveying part 3 from the paper feeding cassette 7 which is selected from the plurality of paper feeding cassettes 7 so as to surely feed the papers 9 one by one to the paper conveying part 3. Here, these four paper feeding cassettes 7 are detachably mounted on the image forming apparatus body 1a.

Further, the paper 9 which is fed to the paper conveying part 3 is conveyed toward the image forming part 4 via a paper feeding path 10. The image forming part 4 is provided for forming a predetermined toner image on the paper 9 using an electrophotographic process. The image forming part 4 includes a photoconductor 11 which constitutes an image carrying body and is pivotally supported in a state that the photoconductor 11 can be rotated in a predetermined direction (in a direction indicated by an arrow X in the drawing) and also includes a charging device 12, an exposure device 13, a developing unit 14, a transfer device 15, a cleaning device 16 and a charge elimination device 17 which are arranged in the periphery of the photoconductor 11 and along the rotational direction of the photoconductor 11.

Further, the charging device 12 includes charging wires to which a high voltage is to be applied. By applying a predetermined potential to a surface of the photoconductor 11 by making use of a corona discharge generated by the charging wires, the surface of the photoconductor 11 is uniformly charged. Then, in the exposure device 13, light based on image data of an original document which is read by the image reading portion 6 is radiated to the photoconductor 11. Accordingly, the surface potential of the photoconductor 11 is selectively attenuated and an electrostatic latent image is formed on the surface of the photoconductor 11. Next, the toner is adhered to the electrostatic latent image by using the developing unit 14 thereby to form a toner image on the surface of the photoconductor 11. Thereafter, the toner image on the surface of the photoconductor 11 is transferred to the paper 9 which is supplied between the photoconductor 11 and the transfer device 15 using the transfer device 15.

Further, the paper 9 to which the toner image has been transferred is conveyed toward the fixing part 5 from the image forming part 4. The fixing part 5 is arranged on a downstream side of the image forming part 4 in the paper conveying direction. The paper 9 to which the toner image has been transferred in the image forming part 4 is sandwiched between a heating roller 18 and a pressing roller 19 which is brought into pressure contact with the heating roller 18 which are provided in the fixing part 5, wherein the paper 9 is also heated by the heating roller 18. As a result, the toner image is fixed to the paper 9. Next, the paper 9 on which the image has been formed through steps of the image forming part 4 and the fixing part 5 is discharged to a discharge tray 21 by a pair of discharge rollers 20. On the other hand, after the toner image is transferred, the toner remaining on the surface of the photoconductor 11 is removed by using the cleaning device 16.

Here, a residual charge on the surface of the photoconductor 11 is removed by using the charge elimination device 17 and the photoconductor 11 is charged again by using the charging device 12. Hereinafter, the image is formed by using the same steps as above.

2. Developing Device

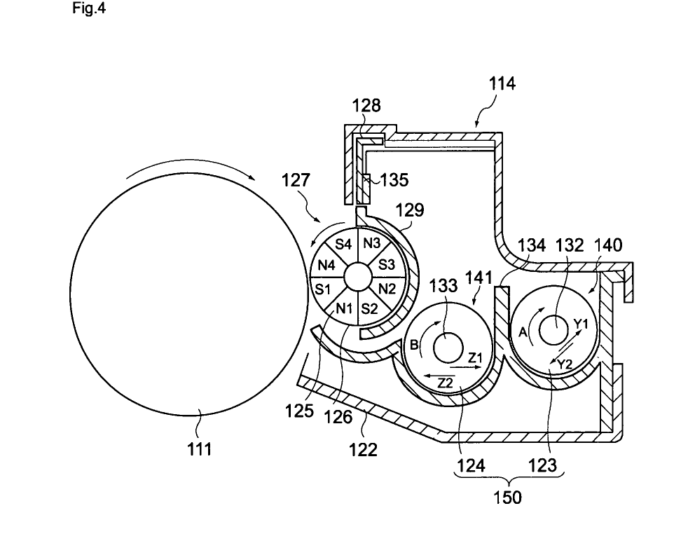

By way of example, as a developing device used in the present invention, a developing device 114 is available. The developing device 114 includes, as shown in FIG. 4, a developing container 122, a developer carrying body 127, a developer layer thickness restricting member 128, and helical pressure springs 150. The developing container 122 accommodates the developer. The developer carrying body 127 carries the developer and conveys the developer to a developing region. The developer layer thickness restricting member 128 restricts the thickness of a layer of the developer. The helical pressure springs 150 rotate about given rotation axes and convey the developer in the rotation axis direction.

Here, the helical pressure springs 150 are constituted of a first spiral member 123 and a second spiral member 124 which constitute conveying means for conveying the toner particles in a predetermined direction.

More specifically, the helical pressure springs 150 are provided with the first spiral member 123 which is composed of a shaft 132 which constitutes a rotatable first shaft, the shaft 132 being arranged inside an agitating chamber 140 for agitating the toner particles therein and spiral blades 130 (not shown) which are mounted on the peripheral surface of the shaft 132. By rotating the first spiral member 123 in the direction indicated by an arrow A in FIG. 4, the toner is conveyed in the longitudinal direction of the shaft 132.

Further, the helical pressure springs 150 are provided with the second spiral member 124 which is composed of a shaft 133 which constitutes a rotatable second shaft, the shaft 133 being arranged in substantially parallel to the shaft 132 and spiral blades (not shown) which are mounted on the peripheral surface of the shaft 133. By rotating the second spiral member 124 in the direction indicated by an arrow B in FIG. 4, the toner is conveyed in the longitudinal direction of the shaft 133.

Here, the first spiral member 123 and the second spiral member 124 are arranged in approximately parallel to each other. Further, a partition member 134, which divides the agitating chamber 140 and a developing chamber 141 in a state that the agitating chamber 140 and the developing chamber 141 are communicable with each other, is provided between the first spiral member 123 and the second spiral member 124. This allows the toner to be conveyed while being agitated in a circulating manner.

Further, as shown in FIG. 4, the developing unit 114 includes the developer carrying body 127 which is compose of a fixed magnet roller 125 and a non-magnetic developing sleeve 126. The fixed magnet roller 125 is arranged on a drum opening side of the developing container 122 and has a plurality of magnetic poles. The non-magnetic developing sleeve 126 accommodates the fixed magnet roller 125 there in and is pivotally and rotatably supported for introducing the accommodated toner to the surface of the photoconductor 111.

Moreover, the developing unit 114 includes a developer layer thickness restricting member 128 and a magnetic body sealing member 129. The developer layer thickness restricting member 128 is formed of a plate-like magnetic body and is arranged in the vicinity of the developing sleeve 126 as well as extends downwardly toward an upper surface of the developing sleeve 126. The magnetic body sealing member 129 is arranged at an end portion of the developing sleeve 126 in the longitudinal direction.

A toner replenishing hole (not shown) is opened above the first spiral member 123 so as to allow the supply of the toner therethrough. That is, the toner supplied is carried into the developing chamber 141 by the first spiral member 123. The toner introduced into the developing chamber 141 is introduced into the developing sleeve 126 by the second spiral member 124. The toner introduced into the developing sleeve 126 is carried on the developing sleeve 126 by a magnetic force of the fixed magnet roller 125. The thickness of the toner is restricted by the developer layer thickness restricting member 128 which is arranged in the vicinity of the developing sleeve 126.

Next, the toner carried on the developing sleeve 126 is guided to a developing position, that is, the surface of the photoconductor 111, by the developer carrying body 127. Due to a contact between the photoconductor 111 and a printing paper, an image is transferred and formed on the printing paper.

The image forming method and the image forming apparatus of the invention are characterized by using the predetermined two-component developer described in the first embodiment.

Therefore, even if image formation is performed continuously for a long time, it is possible to maintain the triboelectrification property in a developer effectively and, as a result, it is possible to stably form a good image in which occurrence of fogging is controlled effectively.

As the image forming method and the image forming apparatus of the invention, a so-called hybrid developing system may be used. The hybrid developing system employs an image forming method in which a developing roller is arranged between a magnet roller and a photoconductor, a thin layer of toner particles is formed on the developing roller, and then the toner particles forming the thin layer are allowed to jump to the photoconductor.

### EXAMPLES

The present invention will be described specifically with reference to examples, but it is needless to say that the invention is not limited the contents thereof.

1. Resin Fine Particle

(1) Preparation of Resin Fine Particles A

Deionized water was fed into a glass reactor equipped with a thermometer, a reflux condenser, a nitrogen gas introducing tube and a stirrer. Then, 1.5 parts by weight of sodium lauryl sulfate as an anionic surfactant was added to 100 parts by weight of the deionized water. Subsequently, the solution was heated to 80° C. under a nitrogen gas atmosphere and then 0.5 parts by weight of ammonium persulfate as a polymerization initiator was added under stirring. Moreover, 50 parts by weight of methyl methacrylate was added dropwise over one hour, followed by stirring for additional one hour, thereby to obtain an emulsion. Subsequently, the resulting emulsion was dried to yield resin fine particles A having an average particle diameter of 91 nm.

(2) Preparation of Resin Fine Particles B

In preparation of resin particles B, the preparation was conducted in the same manner as that of the resin fine particles A except that the addition quantity of sodium lauryl sulfate was 0.5 parts by weight, thereby to obtain resin fine particles B having an average particle diameter of 194 nm.

(3) Preparation of Resin Fine Particles C

In preparation of resin particles C, the preparation was conducted in the same manner as that of the resin fine particles A except that no sodium lauryl sulfate was added and the addition quantity of methyl methacrylate was 150 parts by weight, thereby to obtain resin fine particles C having an average particle diameter of 510 nm.

(4) Preparation of Resin Fine Particles D

In preparation of resin particles D, the preparation was conducted in the same manner as that of the resin fine particles A except that the addition quantity of sodium lauryl sulfate was 5 parts by weight, thereby to obtain resin fine particles D having an average particle diameter of 51 nm.

(5) Preparation of Resin Fine Particles E

In preparation of resin particles E, the preparation was conducted in the same manner as that of the resin fine particles A except that 35 parts by weight of methyl methacrylate and 15 parts by weight of styrene were used instead of 50 parts by weight methyl methacrylate, thereby to obtain resin fine particles E having an average particle diameter of 94 nm.

(6) Preparation of Resin Fine Particles F

In preparation of resin particles F, the preparation was conducted in the same manner as that of the resin fine particles A except that 40 parts by weight of methyl methacrylate and 10 parts by weight of ethylene glycol dimethacrylate were used instead of 50 parts by weight methyl methacrylate, thereby to obtain resin fine particles F having an average particle diameter of 101 nm.

(7) Preparation of Resin Fine Particles G

In preparation of resin particles G, the preparation was conducted in the same manner as that of the resin fine particles A except that 40 parts by weight of methyl methacrylate and 10 parts by weight of divinylbenzene were used instead of 50 parts by weight methyl methacrylate, thereby to obtain resin fine particles G having an average particle diameter of 98 nm.

(8) Preparation of Resin Fine Particles H

In preparation of resin particles H, the preparation was conducted in the same manner as that of the resin fine particles A except that the addition quantity of sodium lauryl sulfate was 10 parts by weight, thereby to obtain resin fine particles H having an average particle diameter of 35 nm.

2. Inorganic Fine Particle

(1) Preparation of Silica Particles

Toluene was fed into a container. To 100 parts by weight of the toluene, 50 parts by weight of dimethyl polysiloxane (produced by Shin-Etsu Chemical Co., Ltd.) and 50 parts by weight of 3-aminopropyl trimethoxysilane (produced by Shin-Etsu Chemical Co., Ltd.) were added and dissolved. This solution was diluted to 10 times with toluene to obtain a diluted solution. Then, for 100 parts by weight of the toluene, prepared was 100 parts by weight of fumed silica (produced by NIPPON AEROSIL Co., Ltd., Fumed Silica #90, average particle diameter: 20 nm). The aforesaid diluted solution was added dropwise slowly to the fumed silica, followed by ultrasonic irradiation and stirring for 30 minutes, thereby obtaining a mixture. Subsequently, the resulting mixture was heated in a high-temperature bath at 150° C., and then the toluene was removed by evaporation with a rotary evaporator. The resulting solid was dried in a reduced pressure drier at a temperature of 50° C. until the weight no longer decreased. Thus, a dried solid was obtained. The resulting dried solid was heated under a nitrogen flow at 200° C. for 3 hours in an electric furnace to yield a powder. The resulting powder was pulverized with a jet mill and collected with a bag filter to obtain silica particles having an average particle diameter of 20 nm and a Vickers hardness of 1100 kg/mm².

(2) Preparation of Titania Particles

In a glass container, 15 g of titanium tert-butoxide and 70 ml of toluene were mixed and dissolved. Then, the glass container was placed in an autoclave (made of stainless steel) purged with nitrogen gas. The autoclave was then heated to 300° C. at a temperature elevation rate of 2.5° C./min and held at 30 kg/cm² for 2 hours. Thereby, the titanium tert-butoxide was subjected to thermal decomposition. Subsequently, the autoclave was cooled and the resulting decomposition product was collected by filtration, washed with acetone, and then dried. The resulting dried decomposition product was pulverized with a jet mill and collected with a bag filter to obtain titania particles having an average particle diameter of 15 nm and a Vickers hardness of 700 kg/mm².

3. Toner Particle

A styrene-acrylic resin was fed into a Henschel mixer. Then, to 100 parts by weight of the styrene-acrylic resin, added and mixed were 4 part by weight of a mold releasing agent, 12 parts by weight of carbon black as a coloring agent and 1 part by weight of a charge control agent. The resulting mixture was melt-kneaded using a twin screw extruder and cooled with a drum flaker. Subsequently, the resulting flakes were coarsely pulverized with a hammer mill, then finely pulverized with a turbo mill, and finally classified with an air classifier to yield toner particles having a volume average particle diameter of 9.09 μm and an average degree of circularity of 0.929.

4. Carrier

(1) Preparation of Carrier A

Into a fluidized bed coating apparatus (produced by Freund Corporation, SFC-5), 10 kg of ferrite having a diameter of 50 μm (produced by Powdertech Co., Ltd., F51-50), 2 kg of tetrafluoroethylene-perfluoro vinyl dissolved in 40 kg of toluene, and 2 kg of Epicoat 1004 (produced by Japan Epoxy Resins Co., Ltd.) were fed. Then, ferrite coating treatment: was conducted under 80° C. hot air blowing. Subsequently, the resulting mixed lump of a covering resin and ferrite was baked at 230° C. for 1 hour in a drier and then cooled and pulverized to yield a carrier A.

(2) Preparation of Carrier B

In the method for producing a carrier B, the preparation was conducted in the same manner as that for the carrier A except that the baking temperature in a drier was changed to 180° C., thereby to obtain a carrier B.

5. Vickers Hardness of Each Kind of Particles

The Vickers hardness of the resin fine particles and the covering resin layers of the carriers were measured.

With regard to the resin fine particles and the covering resin layers of the carriers, each was melted in a cylindrical mold having a diameter of 20 mm and then molded to a thickness of 5 mm to produce a sample. To the sample obtained, a Vickers indenter was applied at a load of 10 g at 25° C. for 15 seconds using a dynamic ultra micro hardness tester (produced by Shimadzu Corporation, DUH-W201). The Vickers hardness was determined based on the indentation in the sample. The results obtained are shown in Table 1.

### Example 1

### 1. Preparation of Developer

Toner particles A were introduced into a Henschel mixer. To 100 parts by weight of the toner particles A, 2 parts by weight of silica particles and 1 part by weight of resin fine particles A were added, and mixed at a condition of 30 m/s for 3 minutes to obtain toner particles added. Subsequently, 10 parts by weight of the resulting added toner particles were added to 100 parts by weight of carrier A and then stirred and mixed uniformly with a Nauta mixer, thereby to obtain a developer A.

### 2. Measurement of Fluorescent X-ray Intensity

(1) Fluorescent X-ray Intensity in a Carrier before use

An intensity (X1) of fluorescent X-rays due to elements derived from the inorganic fine particles in the covering resin layer of a carrier A before use was measured with a fluorescent X-ray measuring apparatus.

Specifically, 0.1 g of the carrier A was fixed to a cell having a transparent tape stuck thereto, and an excessive portion of the carrier was removed by air blowing. Then, an intensity (kcps) of the fluorescent X-ray peak assigned to Si contained in the carrier A was measured with a fluorescent X-ray measuring apparatus (produced by Rigaku Corporation, RIX200) (voltage: 60 kV, current: 30 mA, X-ray tube: Rh).

(2) Fluorescent X-ray Intensity in a Carrier after Continuous Image Formation

An intensity (X2) of fluorescent X-rays due to elements derived from the inorganic fine particles on the covering resin layer of a carrier A after continuous production of 300,000 sheets of image patterns in accordance with ISO 12647 at an image density of 5% was measured with a fluorescent X-ray measuring apparatus.

A developer A was mounted to a color printer (produced by Kyocera Mita Corp., FS-C 5016N). Image patterns in accordance with ISO 12647 were formed on 300,000 sheets continuously at an image density of 5%, and then the carrier A was taken out from the developing unit of the image forming apparatus. Measurement was conducted by use of a fluorescent X-ray measuring apparatus in the same manner as the measurement of the fluorescent X-ray intensity in the aforementioned developer before use except for using such a carrier A after use.

(3) Fluorescent X-ray Intensity Ratio

A value of (X2/X1) as a fluorescent X-ray intensity ratio was calculated from the X1 and X2 obtained. The results are shown in Table 2.

3. Measurement of Charge Quantity

The charge quantity was measured when resin fine particles A and carrier A were mixed and triboelectrified.

That is, 0.3 g of resin fine particles were added to 30 g of a carrier A and mixed with a TURBULA shaker-mixer at a temperature of 20° C. and a humidity of 65% RH for one minute to be triboelectrified. Then, the charge quantity (μC/g) was measured by using a charge measuring apparatus (produced by TREK JAPAN Inc., MODEL 210HS). In this operation, a mesh having 635 meshes (opening=20 μm) was used. The results are shown in Table 3.

The charge quantity was measured when toner particles and carrier A were mixed and triboelectrified.

That is, the measurement was conducted in the same manner as the measurement of the charge quantity of the resin fine particles A except for conducting triboelectrification after adding 10 parts by weight of toner particles to 100 parts by weight of a carrier A. The results are shown in Table 3.

The charge quantity was measured when silica particles and carrier A were mixed and triboelectrified.

That is, the measurement was conducted in the same manner as the measurement of the charge quantity of the resin fine particles A except for conducting triboelectrification after adding 0.5 parts by weight of silica particles to 100 parts by weight of a carrier A. The results are shown in Table 3.

### 4. Evaluation

(1) Evaluation of Image Density

An image density was measured both when 300,000 sheets of image patterns were produced continuously at an image density of 5% in accordance with ISO 12647, and when 50,000 sheets of image patterns were produced intermittently at an image density of 2% in accordance with ISO 12647.

That is, image formation was performed under each condition mentioned above using a color printer (produced by KYOCERA MITA Corp., FS-C 5016N). The images finally formed were measured using a spectrophotometer (produced by GretagMacbeth Co., SpectroEye). The results are shown in Table 2. When the image density (−) is 1.2 or more, it can be determined to be a good image density.

(2) Evaluation of Fogging

A fogging was measured both when 300,000 sheets of image patterns were produced continuously at an image density of 5% in accordance with ISO 12647, and when 50,000 sheets of image patterns were produced intermittently at an image density of 2% in accordance with ISO 12647.

That is, image formation was performed under each condition mentioned above using a color printer (produced by KYOCERA MITA Corp., FS-C 5016N). Unprinted portions of the images finally formed were measured using a spectrophotometer (produced by GretagMacbeth Co., SpectroEye). The results are shown in Table 2. When the fogging (−) is 0.008 or less, it can be determined that fogging is inhibited effectively.

(3) Charge Quantity

A charge quantity of a developer (except for a carrier) was measured both when 300,000 sheets of image patterns were produced continuously at an image density of 5% in accordance with ISO 12647, and when 50,000 sheets of image patterns were produced intermittently at an image density of 2% in accordance with ISO 12647.

That is, image formation was performed under each condition mentioned above using a color printer (produced by KYOCERA MITA Corp., FS-C 5016N). Then, the developer was taken out from the developing unit and the charge quantity (μC/g) was measured by using a charge measuring apparatus (produced by TREK JAPAN Inc., MODEL 210HS). In this operation, a mesh having 635 meshes (opening=20 μm) was used. The results are shown in Table 2. When the charge quantity (μC/g) is 13 μC/g or more, it can be determined to have a sufficient charge quantity.

### Example 2

In Example 2, an evaluation was conducted in the same manner as in Example 1 except that a developer B produced as shown below was used as a developer to be used.

The developer B was prepared in the same manner as the developer A except that 2 parts by weight of resin fine particles B was added instead of adding 1 part by weight of the resin fine particles A. The results are shown in Table 2.

### Example 3

In Example 3, an evaluation was conducted in the same manner as in Example 1 except that a developer C produced as shown below was used as a developer to be used.

The developer C was prepared in the same manner as the developer A except that 5 parts by weight of resin fine particles C was added instead of adding 1 part by weight of the resin fine particles A. The results are shown in Table 2.

### Example 4

In Example 4, an evaluation was conducted in the same manner as in Example 1 except that a developer D produced as shown below was used as a developer to be used.

The developer D was prepared in the same manner as the developer A except that 0.5 parts by weight of resin fine particles D was added instead of adding 1 part by weight of the resin fine particles A. The results are shown in Table 2.

### Example 5

In Example 5, an evaluation was conducted in the same manner as in Example 1 except that a developer E produced as shown below was used as a developer to be used.

The developer E was prepared in the same manner as the developer A except that 1 part by weight of resin fine particles E was added instead of adding 1 part by weight of the resin fine particles A. The results are shown in Table 2.

### Example 6

In Example 6, an evaluation was conducted in the same manner as in Example 1 except that a developer F produced as shown below was used as a developer to be used.

The developer F was prepared in the same manner as the developer A except that 1 part by weight of resin fine particles F was added instead of adding 1 part by weight of the resin fine particles A. The results are shown in Table 2.

### Example 7

In Example 7, an evaluation was conducted in the same manner as in Example 1 except that a developer H produced as shown below was used as a developer to be used.

The developer H was prepared in the same manner as the developer A except that 2 parts by weight of titania particles was added instead of adding 2 parts by weight of the silica particles. The results are shown in Table 2.

### Comparative Example 1

In Comparative Example 1, an evaluation was conducted in the same manner as in Example 1 except that a developer G produced as shown below was used as a developer to be used.

The developer G was prepared in the same manner as the developer A except that 1 part by weight of resin fine particles G was added instead of adding 1 part by weight of the resin fine particles A. The results are shown in Table 2.

### Comparative Example 2

In Comparative Example 2, an evaluation was conducted in the same manner as in Example 1 except that a developer I produced as shown below was used as a developer to be used.

The developer I was prepared in the same manner as the developer A except that 0.7 parts by weight of resin fine particles H was added instead of adding 1 part by weight of the resin fine particles A. The results are shown in Table 2.

### Comparative Example 3

In Comparative Example 3, an evaluation was conducted in the same manner as in Example 1 except that a developer J produced as shown below was used as a developer to be used.

The developer J was prepared in the same manner as the developer A except that 6.5 parts by weight of resin fine particles C was added instead of adding 1 part by the weight of resin fine particles A. The results are shown in Table 2.

### Comparative Example 4

In Comparative Example 4, an evaluation was conducted in the same manner as in Example 1 except that a developer K produced as shown below was used as a developer to be used.

The developer K was prepared in the same manner as the developer A except that 1 part by weight of resin fine particles F was added instead of adding 1 part by weight of the resin fine particles A and a carrier B was used instead of the carrier A. The results are shown in Table 2.

TABLE 1

| | Resin fine particle | | | | | Inorganic fine particle | | | | Carrier | |
|---|---|---|---|---|---|---|---|---|---|---|---|
| | | Monomer | | Average | Addition | | | Average | Addition | | Vickers |
| | | composition | Vickers | particle | quantity | | Vickers | particle | quantity | | hardness |
| | | (weight | hardness | diameter | (part by | | hardness | diameter | (part by | | (kg/ |
| | Kind | ratio) | (kg/mm²) | (nm) | weight) | Kind | (kg/mm²) | (nm) | weight) | Kind | mm²) |
| Developer A | A | MMA | 13 | 91 | 1.0 | Silica | 1100 | 20 | 2.0 | A | 18 |
| Developer B | B | | | 194 | 2.0 | | | | | | |
| Developer C | C | | | 510 | 5.0 | | | | | | |
| Developer D | D | | | 51 | 0.5 | | | | | | |
| Developer E | E | MMA/St | 15 | 94 | 1.0 | | | | | | |
| | | (70/30) | | | | | | | | | |
| Developer F | F | MMA/EGDM | 16 | 101 | 1.0 | | | | | | |
| | | (80/20) | | | | | | | | | |
| Developer G | G | MMA/DVB | 19 | 98 | 1.0 | | | | | | |
| | | (80/20) | | | | | | | | | |
| Developer H | A | MMA | 13 | 91 | 1.0 | Titania | 700 | 15 | | | |
| Developer I | H | | | 35 | 0.7 | Silica | 1100 | 20 | | | |
| Developer J | C | | | 510 | 6.5 | | | | | | |
| Developer K | F | MMA/EGDM | 16 | 101 | 1.0 | | | | | B | 15 |
| | | (80/20) | | | | | | | | | |

TABLE 2

| | | Fluorescent | | | | | | |
|---|---|---|---|---|---|---|---|---|
| | | X-ray intensity | Image density | | Fogging | | Charge quantity | |
| | | ratio (—) | (—) | | (—) | | (μC/m) | |
| | | ISO 5%, | ISO 5%, | ISO 2%, | ISO 5%, | | ISO 5%, | |
| | | 300,000-sheet | 300,000- | 50,000- | 300,000- | ISO 2%, | 300,000- | ISO 2%, |
| | | continuous | sheet | sheet | sheet | 50,000-sheet | sheet | 50,000-sheet |
| | | formation | continuous | intermittent | continuous | intermittent | continuous | intermittent |
| | Developer | (X2/X1) | formation | formation | formation | formation | formation | formation |
| Example 1 | A | 9.3 | 1.399 | 1.359 | 0.002 | 0 | 16.4 | 18.8 |
| Example 2 | B | 8.4 | 1.423 | 1.377 | 0.001 | 0.001 | 15.6 | 18.5 |
| Example 3 | C | 12.6 | 1.325 | 1.301 | 0.002 | 0.001 | 16.1 | 19.6 |
| Example 4 | D | 14.9 | 1.476 | 1.405 | 0.004 | 0.001 | 13.4 | 16.6 |
| Example 5 | E | 8.6 | 1.368 | 1.316 | 0.002 | 0.001 | 15.6 | 18.4 |
| Example 6 | F | 7.2 | 1.393 | 1.348 | 0.001 | 0 | 16.3 | 19.0 |
| Example 7 | H | 5.8 | 1.378 | 1.360 | 0.005 | 0.004 | 13.7 | 14.5 |
| Comparative | G | 15.7 | 1.566 | 1.378 | 0.009 | 0.002 | 9.7 | 17.6 |
| Example 1 | | | | | | | | |
| Comparative | I | 21.1 | 1.567 | 1.377 | 0.011 | 0.001 | 10.6 | 16.3 |
| Example 2 | | | | | | | | |
| Comparative | J | 17.4 | 1.644 | 0.876 | 0.013 | 0.002 | 8.7 | 23.1 |
| Example 3 | | | | | | | | |
| Comparative | K | 33.4 | 1.579 | 1.379 | 0.009 | 0.002 | 12.5 | 19.6 |
| Example 4 | | | | | | | | |

TABLE 3

| | | Charge | | |
|---|---|---|---|---|
| | | quantity | Charge | Charge |
| | | of toner | quantity | quantity of |
| | | particle | of resin fine | inorganic fine |
| | | (μC/g) | particle | particle |
| | | Weight | (μC/g) | (μC/g) |
| | | ratio: 10/100 | Weight ratio: | Weight ratio: |
| | | (toner | 1/100 | 0.5/100 |
| | | particle/ | (resin fine | (inorganic fine |
| | Developer | carrier) | particle/carrier) | particle/carrier) |
| Example 1 | A | 17.6 | −23.5 | 46.5 |
| Example 2 | B | | −19.7 | |
| Example 3 | C | | −16.9 | |
| Example 4 | D | | −29.1 | |
| Example 5 | E | | −14.2 | |
| Example 6 | F | | −20.4 | |
| Example 7 | H | | −23.5 | 0.2 |
| Comparative | G | | −17.8 | 46.5 |
| Example 1 | | | | |
| Comparative | I | | −35.7 | |
| Example 2 | | | | |
| Comparative | J | | −15.1 | |
| Example 3 | | | | |
| Comparative | K | 22.6 | −34.4 | 62.2 |
| Example 4 | | | | |

### INDUSTRIAL APPLICABILITY

According to the two-component developer concerning the present invention, the following advantages can be obtained. When a carrier having a covering resin layer and resin fine particles and inorganic fine particles as additives are used, the intensity ratio of the fluorescent X-rays due to elements derived from the inorganic fine particles on the surface of a carrier before use to that due to elements derived from the inorganic fine particles on the surface of a carrier after a predetermined image formation, is adjusted to a predetermined range, whereby it has become possible to maintain the triboelectrification property of a developer effectively by controlling the degradation of the carrier even when image formation is performed continuously for a long time.

As a result, it has become possible, even when image formation is performed continuously for a long time, to inhibit the generation of fogging effectively.

Accordingly, the two-component developer of the invention is expected to contribute to improvement in durability and in performance in various image forming apparatuses such as copying machines and printers.

What is claimed is:

1. A two-component developer comprising toner particles, resin fine particles, inorganic fine particles and a carrier, wherein
a surface of the carrier has a covering resin layer, and when it is assumed that an intensity of fluorescent X-rays due to elements derived from the inorganic fine particles on the surface of the carrier before use is X1, and an intensity of fluorescent X-rays due to elements derived from the inorganic fine particles on the surface of the carrier after continuous production of 300,000 sheets of image patterns in accordance with ISO 12647 at an image density of 5% is X2, the X1 and X2 satisfy the following relation (1):
X2/X1≦15 (1)

2. The two-component developer according to claim 1, wherein a Vickers hardness of the resin fine particles measured in accordance with JIS B7725 and JIS Z2244 is adjusted to a value smaller than a Vickers hardness of the covering resin layer measured in accordance with the same standards as those for the resin fine particles.

3. The two-component developer according to claim 1, wherein an average primary particle diameter of the resin fine particles is adjusted to a value within the range of from 50 to 500 nm.

4. The two-component developer according to claim 1, wherein an addition quantity of the resin fine particles is adjusted to a value within the range of from 0.1 to 5 parts by weight based on 100 parts by weight of the toner particles.

5. The two-component developer according to claim 1, wherein the resin fine particles comprise an acrylic resin as their major ingredient.

6. The two-component developer according to claim 1, wherein, when a charge quantity per unit mass of the toner particles, a charge quantity per unit mass of the carrier and a charge quantity per unit mass of the resin fine particles are indicated by Q1, Q2 and Q3, respectively, the Q1, Q2 and Q3 satisfy the following relation (2):
Q1>Q2>Q3 (2)

7. An image forming method, wherein the two-component developer according to claim 1 is used.

8. An image forming apparatus, wherein the two-component developer according to claim 1 is used.
